(19) United States
(12) Patent Application Publication
(10) Pub. No.: US 2017/0016196 A1
(43) Pub. Date: Jan. 19, 2017

(54) COVER FOR AN OIL SKIMMER

(71) Applicant: Caterpillar Inc., Peoria, IL (US)

(72) Inventor: Mick RYKHUS, Le Center, MN (US)

(73) Assignee: Caterpillar Inc., Peoria, IL (US)

(21) Appl. No.: 14/801,305

(22) Filed: Jul. 16, 2015

(51) Int. Cl. E02B 15/04; G05B 19/4099; B29C 67/00

(52) U.S. Cl. CPC E02B 15/048; B29C 67/0088; G05B 19/4099; G05B 2219/35134; G05B 2219/49007; B33Y 50/02

(57) ABSTRACT

A cover for an oil skimmer is disclosed. The cover may have a hollow body including an open end and a closed end opposite the open end. The cover may also include a flange attached to and extending outward from the body. The flange may be disposed generally orthogonal to the body. Further, the cover may include a gusset attached to the body and the flange. The gusset may be disposed generally orthogonal to the body and the flange. In addition, the cover may include at least one hole in the flange. The hole may be configured to receive a fastener. The closed end may have a radius that is smaller than half of a width of the open end.

### TECHNICAL FIELD

The present disclosure relates generally to a cover and, more particularly, to a cover for an oil skimmer.

### BACKGROUND

Oil skimmers may include a variety of arrangements of belts, paddles, brushes, and/or pulleys to remove oil, debris, or other contaminants from liquids used in industrial applications. For example, it may be necessary to remove oil and metal shavings from coolant used during a manufacturing process. A typical oil skimmer may include a vertically oriented, pulley driven, endless belt, which may be immersed in a tank of fluid (e.g. coolant). Rotation of one or more pulleys may cause the belt to move up and away from the fluid surface on one side of the tank and re-enter the tank on an opposite side. As the belt moves up and away from the fluid surface, oil and/or debris on the surface of the fluid may adhere to the belt. Wipers or flappers may be arranged adjacent to or in contact with the belt surface to skim off the oil and/or debris from the belt as the belt travels past the wipers. The oil and/or debris removed from the belt by the wipers may be collected and disposed.

U.S. Pat. No. 5,989,422 of Hobson issued on Nov. 23, 1999 (“the '422 patent”) discloses an oil skimmer apparatus. In particular, the '422 patent discloses an endless belt type oil skimmer, which has a head pulley, a tail pulley, and a belt rotating around the head and tail pulleys. The '422 patent discloses that the tail pulley is immersed in the liquid during use. The head pulley of the '422 patent is mounted a vertical distance above the tail pulley. During operation, the belt of the '422 patent picks up oil from the surface of the liquid and carries it upward and around the head pulley. The '422 patent also discloses two wipers that engage the belt as it travels from the head pulley towards the tail pulley to wipe oil from the belt. The '422 patent also discloses a cover that partially covers the pulley and the wipers.

Although the '422 patent discloses a cover for the disclosed oil skimmer, the cover of the '422 patent may still be less than optimal. In particular, the cover of the '422 patent covers the wipers only partially. Thus, oil and/or other debris removed from the belt by the wipers may fall out of the cover on a ground surface around the oil skimmer. Additionally, oil and/or debris from the belt may be flung away from the wipers due to centrifugal forces induced as the belt travels around the head pulley. The oil and/or debris ejected from the belt due to the centrifugal forces may be deposited on inner walls of the disclosed cover and may flow out of the cover and fall on the ground surface around the oil skimmer. As a result, regular cleaning of the ground surface around the oil skimmer may be required, which in turn may add to the cost of the manufacturing processes.

The cover of the present disclosure solves one or more of the problems set forth above and/or other problems of the prior art.

### SUMMARY

In one aspect, the present disclosure is directed to a cover. The cover may include a hollow body including an open end and a closed end opposite the open end. The cover may also include a flange attached to and extending outward from the body. The flange may be disposed generally orthogonal to the body. The cover may include a gusset attached to the body and the flange. The gusset may be disposed generally orthogonal to the body and the flange. In addition, the cover may include at least one hole in the flange configured to receive a fastener. The closed end may have a radius that is smaller than half of a width of the open end.

In another aspect, the present disclosure is directed to a cover. The cover may include a top cover extending from an open end to a closed end. The cover may also include a first side wall attached to the top cover. Further, the cover may include a second side wall attached to the top cover. The second side wall may be disposed opposite the first side wall. The cover may include an end wall attached to the top cover, the first side wall, and the second side wall. The first side wall, the second side wall, the end wall, and the top cover may form a closed end. The first side wall, the second side wall, and the top cover may also define an opening at the open end. The cover may include a flange extending outward from the first side wall. The flange may be disposed generally orthogonal to the first side wall. In addition, the cover may include a gusset attached to the first side wall and the flange. The gusset may be disposed generally orthogonal to the first side wall and the flange. The top cover, the first side wall, the second side wall, the end wall, the flange, and the gusset may be fabricated as a single integral component via a 3-D printing process.

### BRIEF DESCRIPTION OF THE DRAWINGS

FIG. 1 is an illustration of an exemplary disclosed oil skimmer;

FIG. 2 is an illustration of an exemplary disclosed cover for the oil skimmer of FIG. 1;

FIG. 3 is a bottom view of the exemplary disclosed cover of FIG. 2;

FIG. 4 is a top view of the exemplary disclosed cover of FIG. 2;

FIG. 5 is a bottom, rear, left perspective view of the exemplary disclosed cover of FIG. 2;

FIG. 6 is a top, front, left perspective view of the exemplary disclosed cover of FIG. 2;

FIG. 7 is a bottom plan view of the exemplary disclosed cover of FIG. 2;

FIG. 8 is a top plan view of the exemplary disclosed cover of FIG. 2;

FIG. 9 is a right side view of the exemplary disclosed cover of FIG. 2;

FIG. 10 is a left side view of the exemplary disclosed cover of FIG. 2;

FIG. 11 is a rear elevation view of the exemplary disclosed cover of FIG. 2;

FIG. 12 is a front elevation view of the exemplary disclosed cover of FIG. 2; and

FIG. 13 is a schematic drawing representing a system for generating a three-dimensional model of the cover of FIG. 2.

### DETAILED DESCRIPTION

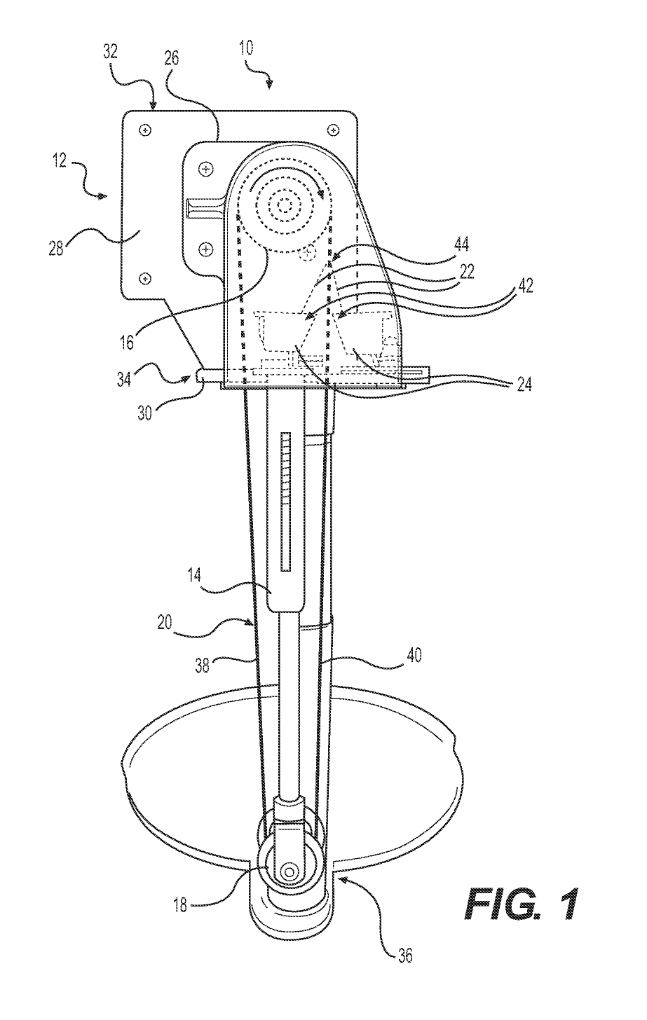

FIG. 1 illustrates an exemplary belt-type oil skimmer 10. Oil skimmer 10 may be fixed or may be portable. In one exemplary embodiment, oil skimmer 10 may be used to remove oil and debris from a tank of liquid associated with a manufacturing operation, for example, machining, stamping, etc. For example, oil skimmer 10 may be immersed in a tank of liquid coolant and may be configured to remove oil and debris from a surface of the liquid coolant.

Oil skimmer 10 may include support member 12, tensioning member 14, first pulley 16, second pulley 18, belt 20, wipers 22, collectors 24, and cover 26. In one exemplary embodiment as illustrated in FIG. 1, support member 12 may include a first plate 28 and a second plate 30. First plate 28 may extend from first end 32 to second end 34. Second plate 30 may be attached to first plate 28 adjacent second end 34. Second plate 30 may be disposed generally orthogonal to first plate 28. Tensioning member 14 may be attached to second plate 30 at second end 34. Tensioning member 14 may extend away from first end 32. Tensioning member 14 may extend between second end 34 and distal end 36 disposed opposite second end 34. Tensioning member 14 may include, for example, a hydraulic actuator, a pneumatic actuator, or a spring driven actuator, which may be configured to alter a length of tensioning member 14.

First pulley 16 may be mounted on first plate 28 between first end 32 and second end 34. Second pulley 18 may be attached to tensioning member 14 at distal end 36. Belt 20 may extend between first pulley 16 and second pulley 18 and may be wrapped around first pulley 16 and second pulley 18. A length of tensioning member 14 may be adjusted to increase or decrease tension in belt 20. First pulley 16 may be drivingly coupled to a power source (not shown), which may rotate first pulley 16. Rotation of first pulley 16 may cause belt 20 to wrap around first and second pulleys 16, 18 and continuously travel between first pulley 16 and second pulley 18.

In one exemplary embodiment as illustrated in FIG. 1, first pulley 16 may rotate in a clockwise direction. Left side 38 of belt 20 may travel from distal end 36 towards first pulley 16 because of the clockwise rotation of first pulley 16. Likewise, right side 40 of belt 20 may travel from first pulley 16 towards distal end 36. Collectors 24 may be mounted on second plate 30. For example, as illustrated in FIG. 1, collectors 24 may be mounted on either side of right side 40 of belt 20. Although only two collectors 24 are shown in FIG. 1, it is contemplated that oil skimmer 10 may have any number of collectors 24.

As further illustrated in FIG. 1, wipers 22 may be arranged on either side of right side 40 of belt 20. Collector ends 42 of wipers 22 may be disposed in collectors 24. Wipers 22 may extend from collector ends 42 to belt ends 44, which may be disposed in contact with or adjacent to right side 40 of belt 20. Oil and/or debris on right side 40 of belt 20 may be skimmed off belt 20 by wipers 22 as right side 40 of belt 20 moves from first pulley 16 towards second pulley 18. The oil or debris removed from right side 40 of belt 20 may accumulate in collectors 24, which may be continuously or periodically emptied. It is contemplated that additional channels, pipes, etc. may be connected to collectors 24 to remove the oil and/or debris accumulated in collectors 24. Although FIG. 1 illustrates first pulley 16 rotating in a clockwise direction, it is contemplated that first pulley 16 may instead rotate in a counterclockwise direction. It is further contemplated that when first pulley 16 rotates in a counter-clockwise direction, wipers 22 and collectors 24 may be disposed on either side of left side 38 of belt 20 to skim off oil and/or debris from left side 38 of belt 20 as belt 20 travels from first pulley 16 towards second pulley 18.

Cover 26 may be attached to first plate 28. Cover 26 may extend from adjacent second end 34 to adjacent first end 32. In one exemplary embodiment as illustrated in FIG. 1, cover 26 may extend from a location adjacent second end 34 but between second end 34 and distal end 36. Thus, cover 26 may substantially completely cover first pulley 16, wipers 22, and collectors 24. Cover 26 may be attached to first plate 28 such that there may be a clearance between cover 26 and first pulley 16. In one exemplary embodiment, the clearance may range from about 3 mm to 5 mm. As used in this disclosure, the terms “about” and “generally” indicate typical manufacturing tolerances and dimensional rounding. Thus, for example, a clearance of about 3 mm suggests that the clearance may range from 2.9 mm to 3.1 mm. Likewise, a clearance of about 5 mm suggests that the clearance may range from 4.9 mm to 5.1 mm.

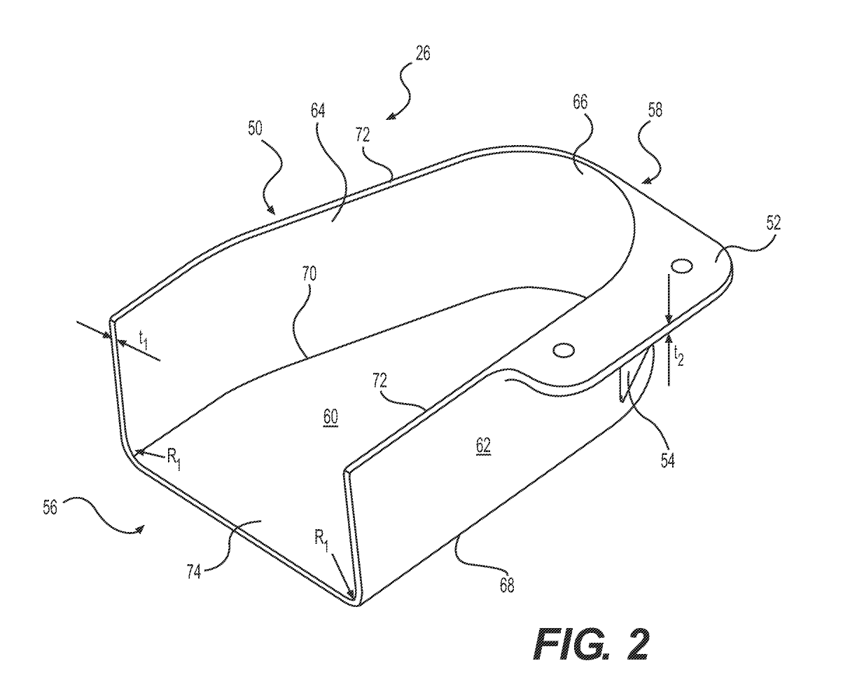

FIG. 2 illustrates a bottom perspective view of an exemplary disclosed embodiment of cover 26. Cover 26 may include body 50, flange 52, and gusset 54. Body 50 may be hollow and may have an open end 56 and may extend from open end 56 to closed end 58, which may be disposed opposite open end 56. As illustrated in FIG. 2, body 50 may include top cover 60, first side wall 62, second side wall 64, and end wall 66. Top cover 60 may extend from open end 56 to closed end 58 and from first edge 68 to second edge 70 disposed opposite first edge 68. First side wall 62 may extend outward from top cover 60 to outer edge 72. First side wall 62 may be attached to top cover 60 along first edge 68 of top cover 60. In one exemplary embodiment as illustrated in FIG. 2, first side wall 62 may be disposed generally orthogonal to top cover 60. Further, as illustrated in FIG. 2, first side wall 62 may be attached to top cover 60 via smooth rounded edges having radii “R₁.” In one exemplary embodiment, radius R₁ may range from about 4 mm to 7 mm. Second side wall 64 may extend outward from top cover 60 to outer edge 72. Second side wall 64 may be disposed opposite first side wall 62 and may be attached to top cover 60 along second edge 70. In one exemplary embodiment as illustrated in FIG. 2, second side wall 64 may be disposed generally orthogonal to top cover 60. Further, as illustrated in FIG. 2, second side wall 64 may be attached to top cover 60 via smooth rounded edges having the radius R₁. First side wall 62, top cover 60, and second side wall 64 may form a generally U-shaped channel adjacent open end 56 that may also define an opening 74. Belt 20 may pass through opening 74. First pulley 16, left and right sides 38, 40 of belt 20, wipers 22, and collectors 24 may fit within the hollow body 50 when cover 26 is attached to first plate 28 (see FIG. 1).

End wall 66 may extend outward from top cover 60 to outer edge 72. End wall 66 may be attached to top cover 60, first side wall 62, and second side wall 64, forming closed end 58. Like first side wall 62 and second side wall 64, end wall 66 may also be disposed generally orthogonal to top cover 60. It is contemplated, however, that first side wall 62, second side wall 64, and end wall 66 may be disposed at an angle relative to top cover 60. For example, one or more of first side wall 62, second side wall 64, and end wall 66 may be inclined relative to both top cover 60 and to a plane orthogonal to top cover 60. Top cover 60, first side wall 62, second side wall 64, and end wall 66 may have the same or different thickness “t₁.” In one exemplary embodiment, thickness t₁ ranges from 3 mm to 6 mm. Although first side wall 62 and second side wall 64 have been illustrated as having substantially planar shapes with substantially uniform thicknesses t₁ in FIG. 2, it is contemplated that first side wall 62 and second side wall 64 may be non-planar and may have a non-uniform thickness.

Flange 52 may be attached to body 50 adjacent outer edge 72. Flange 52 may extend outward from body 50. For example, flange 52 may be attached to and may extend outward from first side wall 62 and end wall 66. In one exemplary embodiment as illustrated in FIG. 2, flange 52 may be disposed generally orthogonal to first side wall 62 and end wall 66 and may be disposed generally parallel to top cover 60. Flange 52 may have a thickness “t₂,” which may be the same as or different from thickness t₁ of top cover 60, first side wall 62, second side wall 64, and end wall 66. In one exemplary embodiment, thickness t₂ may range from about 4 mm to 8 mm. Flange 52 may abut first plate 28 (see FIG. 1) of oil skimmer 10.

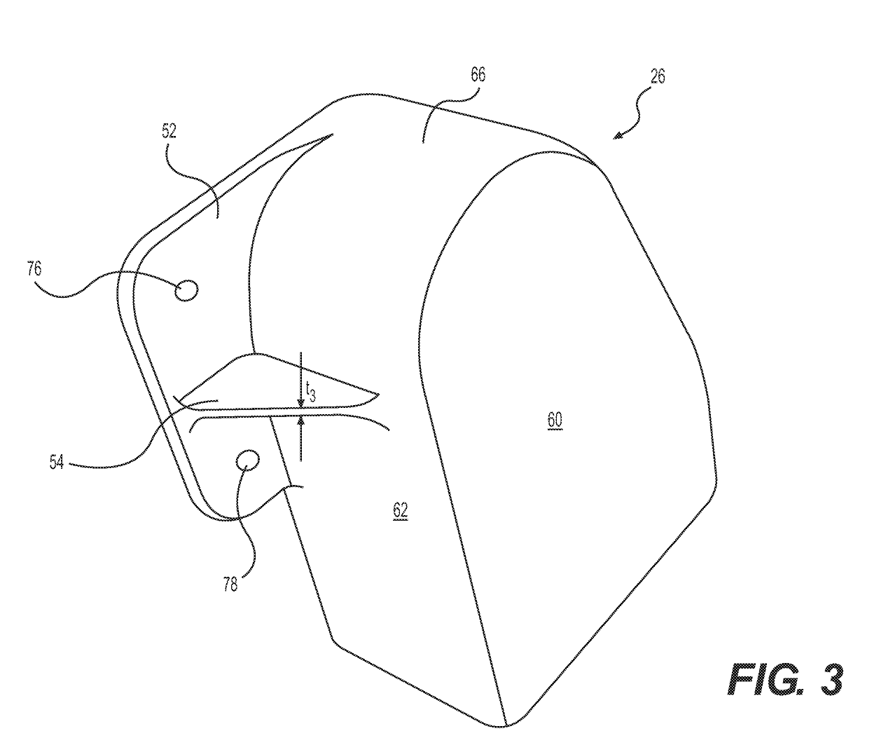

FIG. 3 illustrates another view of the exemplary disclosed embodiment of cover 26. As illustrated in FIG. 3, cover 26 may include gusset 54, which may be attached to both first side wall 62 and flange 52. Gusset 54 may be disposed generally orthogonal to both first side wall 62 and flange 52. It is contemplated, however, that gusset 54 may be inclined relative to one or both of first side wall 62 and flange 52. Gusset 54 may have a generally triangular shape with two orthogonal edges attached to first side wall 62 and flange 52. Gusset 54 may have a thickness “t₃,” which may be the same as or different from thicknesses t₁ and t₂. In one exemplary embodiment, thickness t3 may range from 3 mm to 8 mm.

Flange 52 may include a first hole 76 disposed on one side of gusset 54 and a second hole 78 disposed on an opposite side of gusset 54. First and second holes 76 may be generally cylindrical through holes configured to receive fasteners (not shown), which may be used to attach flange 52 to first plate 28 (see FIG. 1). It is also contemplated that in some exemplary embodiments, first and second holes 76 may be threaded. Although FIG. 3 illustrates only two holes 76, 78, it is contemplated that flange 52 may have any number of holes 76 and/or 78, which may receive fasteners (not shown) configured to attach flange 52 with first plate 28 of oil skimmer 10. Locating first and second holes 76, 78 on opposite sides of gusset 54 may help ensure that cover 26 is firmly attachable to first plate 28. Attachment of flange 52 via at least two holes 76, 78 may also help ensure that cover 26 does not rotate relative to first plate 28 during operation of oil skimmer 10.

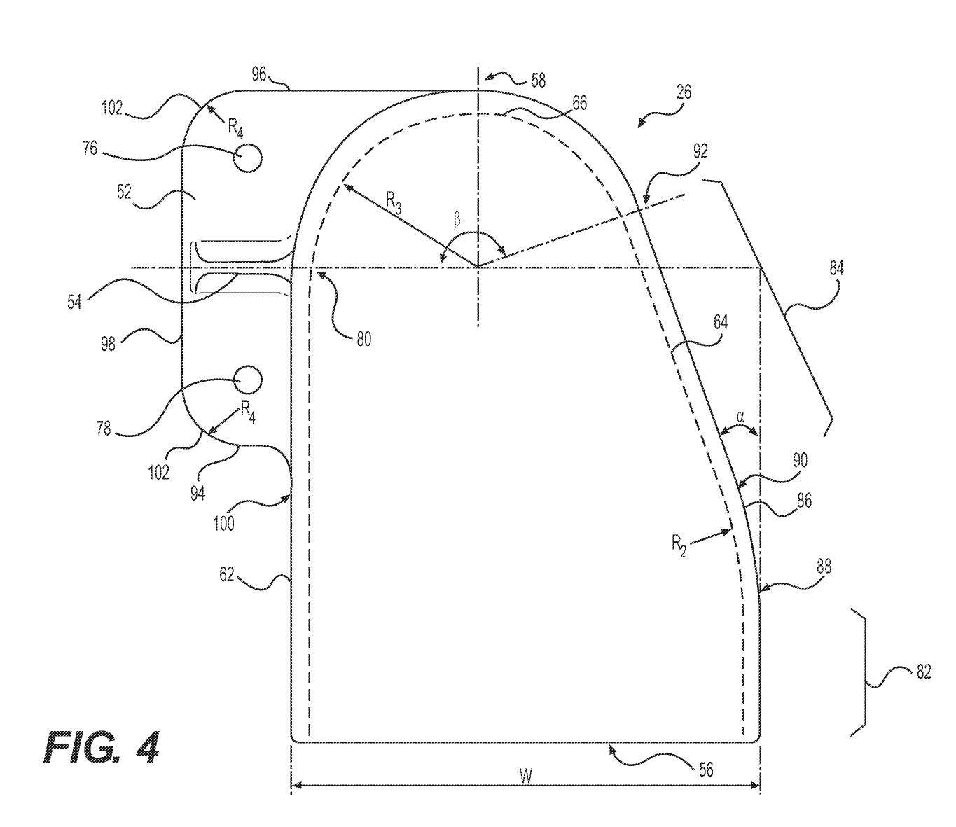

FIG. 4 illustrates a top view of the exemplary disclosed embodiment of cover 26. As illustrated in FIG. 4, first side wall 62 extends from open end 56 to first intermediate point 80 disposed between open end 56 and closed end 58. In one exemplary embodiment as illustrated in FIG. 4, gusset 54 may be attached to first side wall 62 and flange 52 at first intermediate point 80. It is contemplated, however, the gusset 54 may be attached to first side wall 62 and flange 52 at any location between open end 56 and first intermediate point 80.

As further illustrated in FIG. 4, second side wall 64 may have a first section 82, a second section 84, and a curved section 86. First section 82 of second side wall 64 may extend from open end 56 to second intermediate point 88, which may be located between open end 56 and first intermediate point 80. First section 82 of second side wall 64 may be disposed generally parallel to first side wall 62 and generally orthogonal to top cover 60. Second section 84 of second side wall 64 may extend from third intermediate point 90 to fourth intermediate point 92. In one exemplary embodiment as illustrate in FIG. 4, third intermediate point 90 may be located between first intermediate point 80 and second intermediate point 88, and fourth intermediate point 92 may be located between first intermediate point 80 and closed end 58. First section 82 and second section 84 may be connected to each other via curved section 86, which may extend from second intermediate point 88 to third intermediate point 90. Curved section 86 may have a radius “R₂.” Radius R₂ may be selected to help ensure that oil flowing along second side wall 64 may be directed to flow into one of the collectors 24 instead of falling out of opening 74 on to the ground surface around oil skimmer 10. In one exemplary embodiment, radius R₂ may range from about 55 mm to 65 mm.

Like first section 82, both second section 84 and curved section 86 may be disposed generally orthogonal to top cover 60. As illustrated in FIG. 4, however, second section 84 of second side wall 64 may be inclined at an angle “a” relative to first section 82. One of ordinary skill in the art would recognize that second section 84 may also be inclined relative to first side wall 62. Angle α may be selected to ensure that oil or debris wiped out or thrown outward from belt 20 may be directed to collectors 24 instead of falling out of opening 74 and onto the ground area around oil skimmer 10. In one exemplary embodiment, angle α may range from about 5° to 45°. Angle α as illustrated in FIG. 4 was selected for its pleasing appearance. As discussed above, the term “about” indicates typical manufacturing tolerances and/or rounding. Thus, for example, about 15° may indicate a range of 15°±0.1° and about 30° may indicate a range of 30°±0.1°.

End wall 66 may be disposed orthogonal to top cover 60. End wall 66 may extend from first intermediate point 80 to fourth intermediate point 92. In one exemplary embodiment as illustrated in FIG. 4, end wall 66 may have a generally cylindrical shape having a radius “R₃.” Radius R₃ may be selected so as to leave a clearance between first pulley 16 and end wall 66. It is also contemplated that radius R₃ may be smaller than half of the width “W” of the U-shaped channel formed by first side wall 62, top cover 60 and second side wall 64 at open end 56. In one exemplary embodiment, radius R₃ may range from about 25 mm to 35 mm and the clearance may range from about 4 mm to 6 mm. As also illustrated in FIG. 4, end wall 66 may not form a complete semi-circle and instead may comprise a segment of a circle of radius R₂, spanning an angle “β” between first intermediate point 80 and fourth intermediate point 92. Angle β may be less than about 180°. Angle β may range between about 150° and about 165°. Angle β may also be selected so as to ensure that oil and debris thrown outward from belt 20, due to centrifugal forces as belt 20 moves over first pulley 16, can be captured and directed to collectors 24 instead of allowing the oil and debris to fall out of opening 74 on the ground area around oil skimmer 10.

As also illustrated in FIG. 4, flange 52 may extend from flange proximate edge 94 to flange distal edge 96 and from first side wall 62 to flange outer edge 98. Flange outer edge 98 may be disposed generally orthogonal to both flange proximate edge 94 and flange distal edge 96. Flange proximate edge 94 may be disposed at a fifth intermediate point 100, which may be located between open end 56 and first intermediate point 80. Flange distal edge 96 may be disposed generally parallel to opening 74 and generally tangential to end wall 66 at closed end 58. Flange outer edge 98 may be joined with flange proximate edge 94 and flange distal edge 96 via rounded edges 102. Rounded edges 102 may have a radius of curvature R₄, which may range from 5 mm to 10 mm.

In one exemplary embodiment as illustrated in FIG. 4, first hole 76 and second hole 78 may be located midway between first side wall 62 and flange outer edge 98. Likewise, first hole 76 may be located midway between gusset 54 and flange distal edge 96 and second hole 78 may be located midway between gusset 54 and flange proximate edge 94. It is contemplated, however, that first hole 76 and second hole 78 may be located anywhere on flange 52. Likewise, the positions of first intermediate point 80, second intermediate point 88, third intermediate point 90, fourth intermediate point 92, and fifth intermediate point 100 relative to each other may differ from the positions described above with respect to the exemplary embodiments of cover 26 illustrated in FIGS. 2-4.

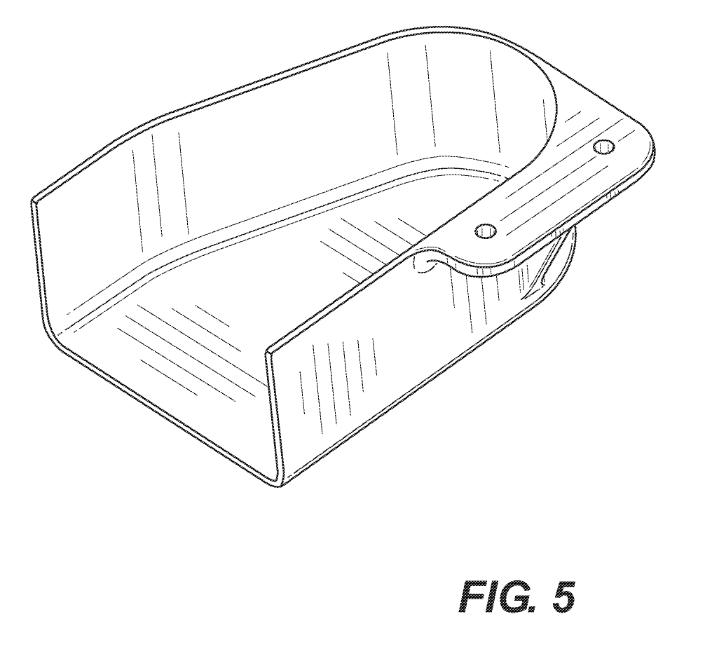

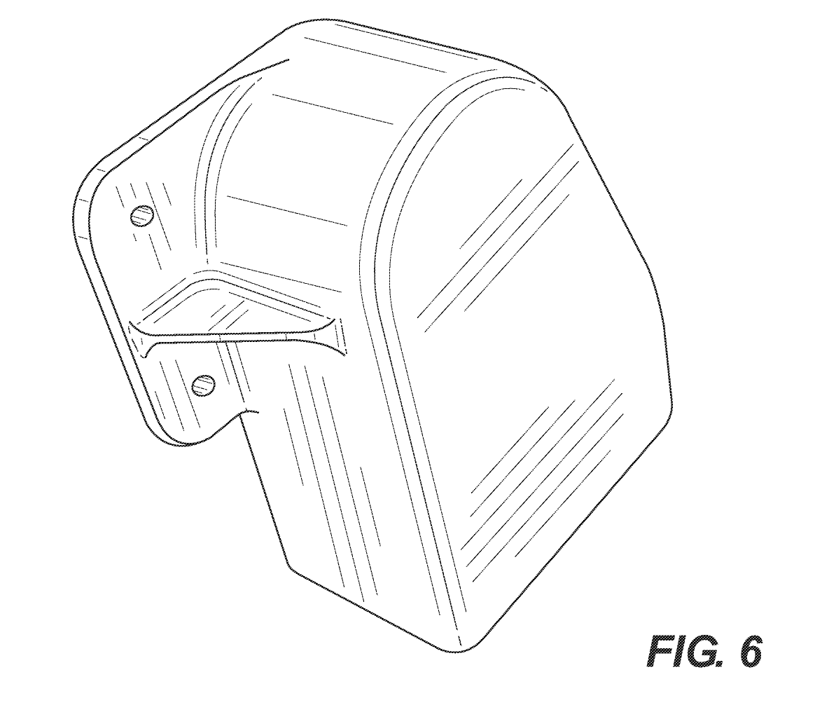

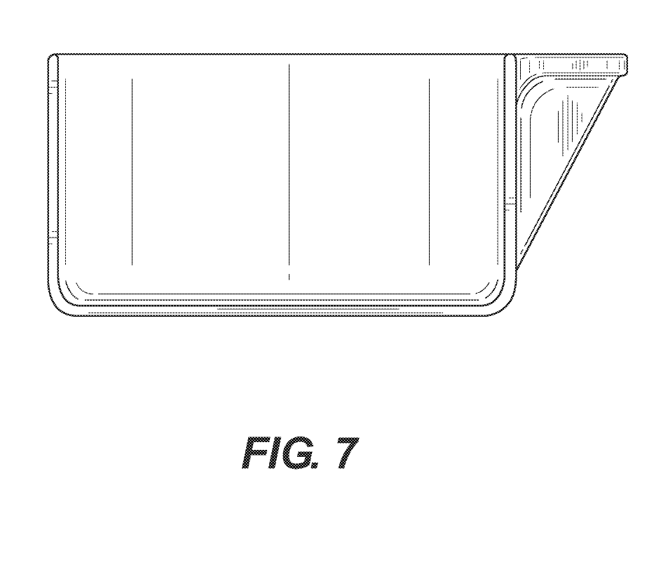

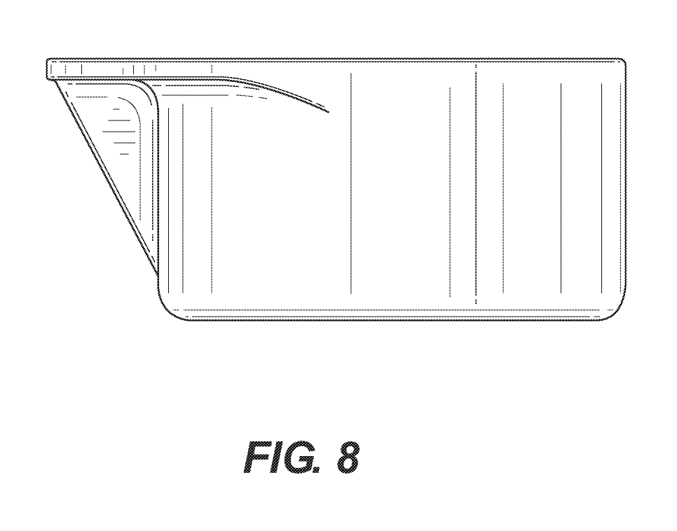

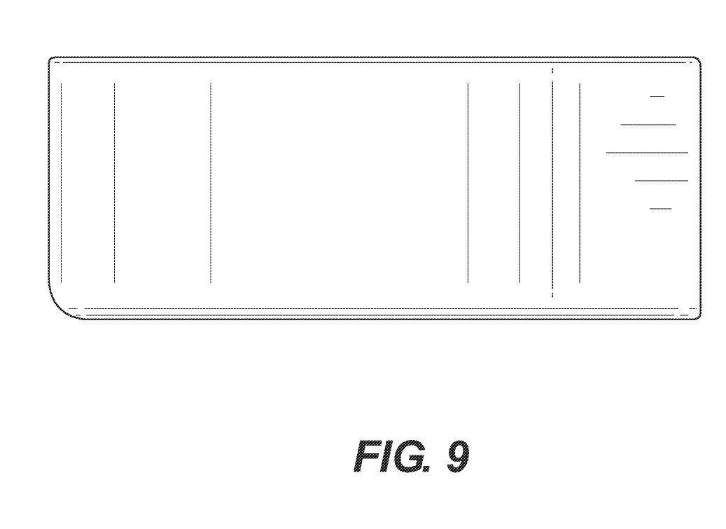

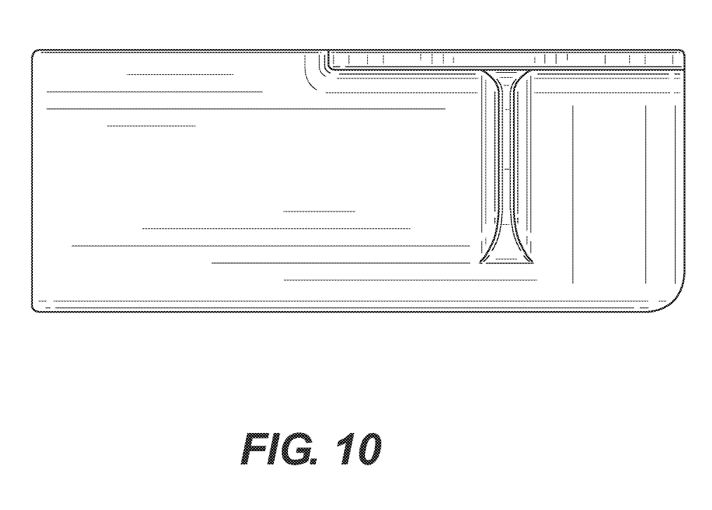

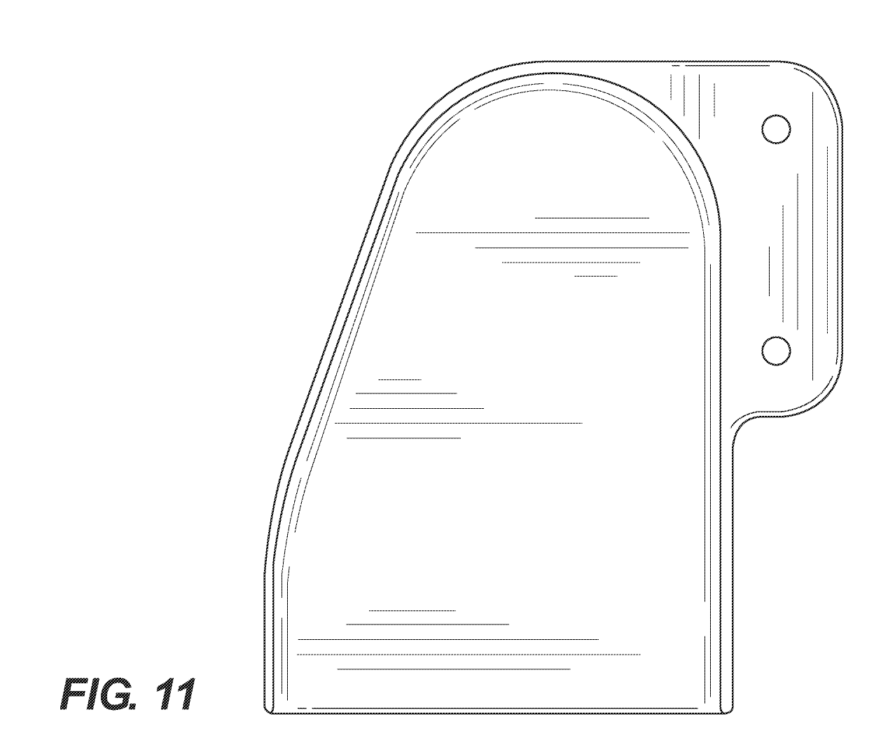

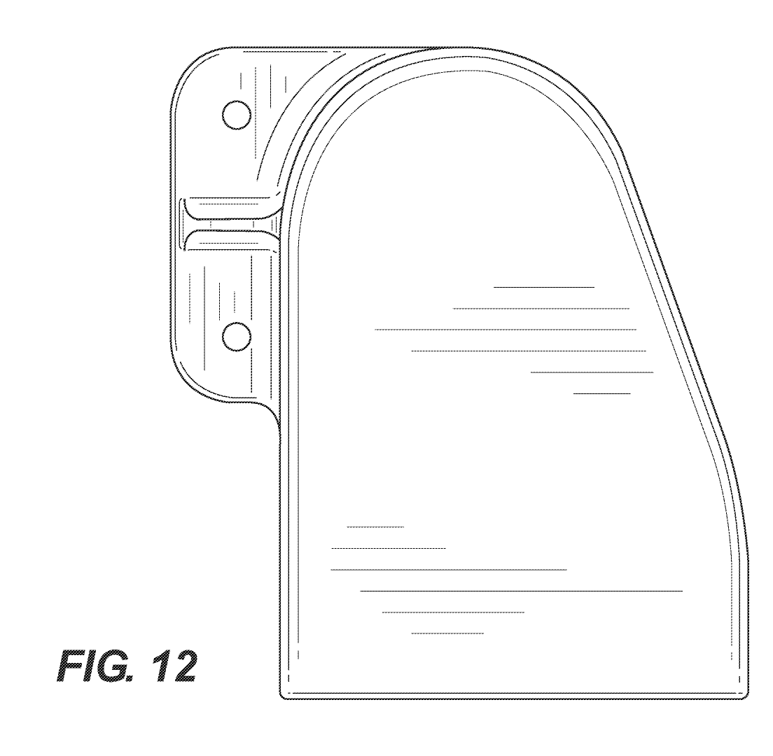

FIGS. 5-12 illustrate various perspective views of cover 26. For example, FIG. 5 illustrates a bottom, rear, left perspective view of cover 26. FIG. 6 illustrates a top, front, left perspective view of cover 26. FIG. 7 illustrates a bottom plan view of cover 26. FIG. 8 illustrates a top plan view of cover 26. FIG. 9 illustrates a right side view of cover 26. FIG. 10 illustrates a left side view of cover 26. FIG. 11 illustrates a rear elevation view of cover 26. And, FIG. 12 illustrates a front elevation view of cover 26.

### INDUSTRIAL APPLICABILITY

The disclosed cover for an oil skimmer may provide several advantages. For example, cover 26 may help ensure that during operation of oil skimmer 10, hair, loose clothing, or other implements may not become trapped or snagged by first pulley 16 or belt 20. Further, oil and/or debris carried by belt 20 may be expected to be ejected from belt 20 as belt 20 rolls over first pulley 16 because of centrifugal forces induced on the oil and/or debris by the rotating first pulley 16. Cover 26 may help ensure that oil and/or debris flung outward from belt 20 may not fall on the ground around oil skimmer 10. Instead, cover 26 may help direct the oil and/or debris to one of the collectors 24. Additionally the use of rounded surfaces to connect top cover 60, first side wall 62, second side wall 64, and end wall 66 may help ensure ease of assembly of cover 26 on first plate 28 of oil skimmer 10. The rounded surfaces may also help to prevent stress-induced cracks or fractures in cover 26 during use, assembly, and disassembly.

As also discussed above, the angular span 13 of end wall 66 and inclination a of second section 84 of second side wall 64 may help guide oil and/or debris deposited on second side wall 64 to be deposited in collectors 24. In addition, selecting angles 13 and a as discussed above may reduce an amount of material required to manufacture cover 26 while still ensuring that cover 26 completely covers first pulley 16, wipers 22, and collectors 24 so as to capture most of the oil and/or debris that may be wiped off or ejected from belt 20.

The disclosed cover 26 may be manufactured using conventional techniques such as, for example, stamping, casting, machining, or molding. Alternatively, the disclosed cover 26 may be manufactured using conventional techniques generally referred to as additive manufacturing or additive fabrication. For example, at conclusion of the additive manufacturing process, flange 52, gusset 54, top cover 60, first side wall 62, second side wall 64, and end wall 66 may be integrally formed as a single component. Known additive manufacturing/fabrication processes include techniques such as, for example, 3D printing. 3D printing is a process wherein material may be deposited in successive layers under the control of a computer. The computer controls additive fabrication equipment to deposit the successive layers according to a three-dimensional model (e.g. a digital file such as an AMF or STL file) that is configured to be converted into a plurality of slices, for example substantially two-dimensional slices, that each define a cross-sectional layer of the cover 26 in order to manufacture, or fabricate, the cover 26. In one case, the disclosed cover 26 would be an original component and the 3D printing process would be utilized to manufacture the cover 26. In other cases, the 3D process could be used to replicate an existing cover 26 and the replicated cover 26 could be sold as aftermarket parts. These replicated aftermarket cover 26 could be either exact copies of the original cover 26 or pseudo copies differing in only non-critical aspects.

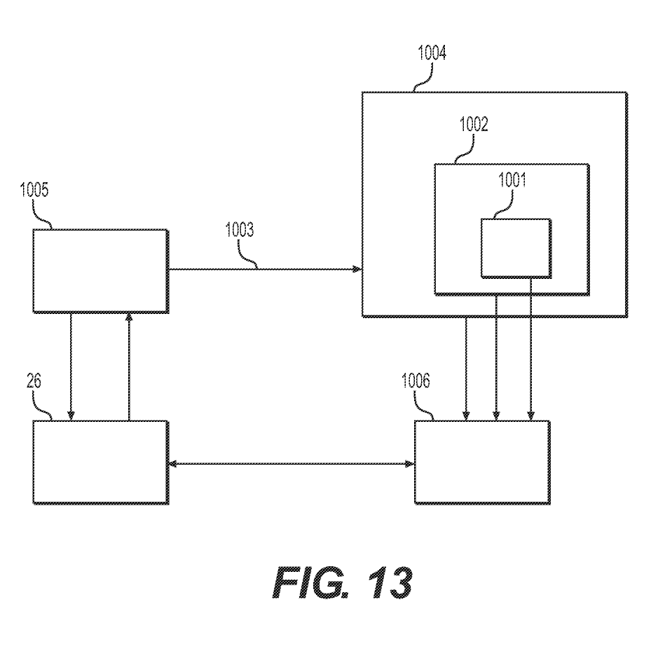

With reference to FIG. 13, the three-dimensional model 1001 used to represent an original cover 26 may be on a computer-readable storage medium 1002 such as, for example, magnetic storage including floppy disk, hard disk, or magnetic tape; semiconductor storage such as solid state disk (SSD) or flash memory; optical disc storage; magneto-optical disc storage; or any other type of physical memory on which information or data readable by at least one processor may be stored. This storage medium may be used in connection with commercially available 3D printers 1006 to manufacture, or fabricate, the cover 26. Alternatively, the three-dimensional model may be transmitted electronically to the 3D printer 1006 in a streaming fashion without being permanently stored at the location of the 3D printer 1006. In either case, the three-dimensional model constitutes a digital representation of the cover 26 suitable for use in manufacturing the cover 26.

The three-dimensional model may be formed in a number of known ways. In general, the three-dimensional model is created by inputting data 1003 representing the cover 26 to a computer or a processor 1004 such as a cloud-based software operating system. The data may then be used as a three-dimensional model representing the physical cover 26. The three-dimensional model is intended to be suitable for the purposes of manufacturing the cover 26. In an exemplary embodiment, the three-dimensional model is suitable for the purpose of manufacturing the cover 26 by an additive manufacturing technique.

In one embodiment depicted in FIG. 13, the inputting of data may be achieved with a 3D scanner 1005. The method may involve contacting the cover 26 via a contacting and data receiving device and receiving data from the contacting in order to generate the three-dimensional model. For example, 3D scanner 1005 may be a contact-type scanner. The scanned data may be imported into a 3D modeling software program to prepare a digital data set. In one embodiment, the contacting may occur via direct physical contact using a coordinate measuring machine that measures the physical structure of the cover 26 by contacting a probe with the surfaces of the cover 26 in order to generate a three-dimensional model. In other embodiments, the 3D scanner 1005 may be a non-contact type scanner and the method may include directing projected energy (e.g. light or ultrasonic) onto the cover 26 to be replicated and receiving the reflected energy. From this reflected energy, a computer would generate a computer-readable three-dimensional model for use in manufacturing the cover 26. In various embodiments, multiple 2D images can be used to create a three-dimensional model. For example, 2D slices of a 3D object can be combined to create the three-dimensional model. In lieu of a 3D scanner, the inputting of data may be done using computer-aided design (CAD) software. In this case, the three-dimensional model may be formed by generating a virtual 3D model of the disclosed cover 26 using the CAD software. A three-dimensional model would be generated from the CAD virtual 3D model in order to manufacture the cover 26.

The additive manufacturing process utilized to create the disclosed cover 26 may involve materials such as plastic, rubber, metal, etc. In some embodiments, additional processes may be performed to create a finished product. Such additional processes may include, for example, one or more of cleaning, hardening, heat treatment, material removal, and polishing. Other processes necessary to complete a finished product may be performed in addition to or in lieu of these identified processes.

It will be apparent to those skilled in the art that various modifications and variations can be made to the disclosed cover. Other embodiments will be apparent to those skilled in the art from consideration of the specification and practice of the disclosed cover. It is intended that the specification and examples be considered as exemplary only, with a true scope being indicated by the following claims and their equivalents.

What is claimed is:

1. A cover for an oil skimmer, comprising:
a hollow body including an open end and a closed end opposite the open end;
a flange attached to and extending outward from the body, the flange being disposed generally orthogonal to the body;
a gusset attached to the body and the flange, the gusset being disposed generally orthogonal to the body and the flange; and
at least one hole in the flange configured to receive a fastener, wherein the closed end has a radius that is smaller than half of a width of the open end.

2. The cover of claim 1, wherein the at least one hole is a first hole and the cover includes a second hole disposed on the flange such that the first hole and the second hole are disposed on opposite sides of the gusset.

3. The cover of claim 1, wherein the cover is made using one of injection molding, sheet metal stamping, casting, machining, or 3D printing.

4. The cover of claim 1, wherein the body includes:
a top cover extending from the open end to the closed end;
a first side wall attached to the top cover, the first side wall extending from the open end to a first intermediate point between the open end and the closed end;
a second side wall attached to the top cover, the second side wall being disposed opposite the first side wall, the second side wall extending from the open end to a second intermediate point between the open end and the closed end; and
an end wall attached to the cover, the end wall extending between the first intermediate point and the second intermediate point.

5. The cover of claim 4, wherein the end wall has a generally cylindrical shape.

6. The cover of claim 4, wherein the second side wall includes:
a first section extending from the open end to a third intermediate point disposed between the open end and the first intermediate point;
a second section extending from a fourth intermediate point to the second intermediate point, the fourth intermediate point being disposed between the third intermediate point and the closed end, and the second section being inclined relative to the first section and the first side wall; and
a curved section connecting the first section and the second section, the curved section extending from the third intermediate point to the fourth intermediate point.

7. The cover of claim 6, wherein an angle of inclination of the second section relative to the first section ranges from about 5° to about 45°.

8. The cover of claim 6, wherein the radius of the curved section ranges from about 55 mm to 65 mm.

9. The cover of claim 4, wherein the first side wall, the top cover, and the second side wall form a generally U-shaped channel at the open end.

10. The cover of claim 9, wherein the end wall is a segment of a circle having the radius and spanning an angle less than 180°.

11. The cover of claim 4, wherein
the first side wall extends generally orthogonally from the top cover to an outer edge,
the flange is disposed at the outer edge, the flange extending outward from the first side wall to a flange outer edge, the flange also extending from a flange proximate edge to a flange distal edge, and
the flange proximate edge is disposed between the open end and the first intermediate point.

12. The cover of claim 11, wherein the gusset is disposed at the first intermediate point.

13. The cover of claim 4, wherein the first side wall, the second side wall, and the end wall have the same height and thickness.

14. A cover for an oil skimmer, comprising:
a top cover extending from an open end to a closed end;
a first side wall attached to the top cover;
a second side wall attached to the top cover, the second side wall being disposed opposite the first side wall;
an end wall attached to the top cover, the first side wall, and the second side wall,
the first side wall, the second side wall, the end wall, and the top cover forming the closed end, and
the first side wall, the second side wall, and the top cover defining an opening at the open end;
a flange extending outward from the first side wall, the flange being disposed generally orthogonal to the first side wall; and
a gusset attached to the first side wall and the flange, the gusset being disposed generally orthogonal to the first side wall and the flange,
wherein the top cover, the first side wall, the second side wall, the end wall, the flange, and the gusset are fabricated as a single integral component via 3D printing.

15. The cover of claim 14, wherein the first side wall, the second side wall, and the end wall are disposed generally orthogonal to the top cover.

16. The cover of claim 14, wherein
the first side wall extends from the open end to a first intermediate point disposed between the open end and the closed end,
the second side wall includes:
a first section extending from the open end to a second intermediate point disposed between the open end and the first intermediate point; and
a second section extending from a third intermediate point to a fourth intermediate point, the third intermediate point being disposed between the first intermediate point and the second intermediate point and the fourth intermediate point being disposed between the first intermediate point and the closed end, and
the end wall extends from the first intermediate point to the fourth intermediate point.

17. The cover of claim 16, wherein
the first side wall and the second side wall are disposed generally orthogonal to the top cover, and
the second section is inclined relative to the first side wall and the first section.

18. The cover of claim 15, wherein
the first side wall extends from the top cover to an outer edge,
the flange extends from the outer edge to a flange outer edge and between a flange proximate edge and a flange distal edge, wherein the flange outer edge is disposed generally orthogonal to the flange proximate edge and the flange distal edge.

19. The cover of claim 18, further including:
a first hole in the flange, the first hole being disposed on one side of the gusset; and
a second hole in the flange, the second hole being disposed on an opposite side of the gusset.

20. The cover of claim 18, wherein the flange outer edge may be joined with the flange proximate edge and the flange distal edge via rounded edges having a radius ranging from about 5 mm to about 10 mm.

21. A method of creating a computer-readable three-dimensional model suitable for use in manufacturing the cover of claim 1, the method comprising:
inputting data representing the cover to a computer; and
using the data to represent the cover as a three-dimensional model, the three dimensional model being suitable for use in manufacturing the cover.

22. The method of claim 21, wherein the inputting of data includes one or more of using a contact-type 3D scanner to contact the cover, using a non-contact 3D scanner to project energy onto the cover and receive reflected energy, and generating a virtual three-dimensional model of the cover using computer-aided design (CAD) software.

23. A computer-readable three-dimensional model suitable for use in manufacturing the cover of claim 1.

24. A computer-readable storage medium having data stored thereon representing a three-dimensional model suitable for use in manufacturing the cover of claim 1.

25. A method for manufacturing the cover of claim 1, the method comprising the steps of:
providing a computer-readable three-dimensional model of the cover, the three-dimensional model being configured to be converted into a plurality of slices that each define a cross-sectional layer of the cover; and
successively forming each layer of the cover by additive manufacturing.
